(19) United States
(12) Patent Application Publication
(10) Pub. No.: US 2017/0072793 A1
(43) Pub. Date: Mar. 16, 2017

(54) POWER TAKE OFF HAVING ADJUSTABLE CLUTCH ACTUATION RATE

(71) Applicant: Parker-Hannifin Corporation, Cleveland, OH (US)

(72) Inventor: James Blalock, Olive Branch, MS (US)

(73) Assignee: Parker-Hannifin Corporation, Cleveland, OH (US)

(21) Appl. No.: 15/308,952

(22) PCT Filed: May 28, 2015
(86) PCT No.: PCT/US2015/032904

§ 371 Date: Nov. 4, 2016

Related U.S. Application Data
(60) Provisional application No. 62/003,920, filed on May 28, 2014.

(51) Int. Cl. B60K 17/28; F16D 25/0638; F16H 57/00; F16D 13/52

(52) U.S. Cl. CPC B60K 17/28; F16D 13/52; F16D 25/0638; F16H 57/0018

(57) ABSTRACT

A power take off unit includes an output gear having a hydraulic circuit. The hydraulic circuit is an internal hydraulic circuit that is in fluid communication with an internal clutch assembly. The hydraulic circuit includes a flow-restrictive passage that modulates the flow of hydraulic fluid in order to provide a soft start clutch engagement that reduces shock loads associated with loads produced when starting torque is applied to the attached equipment.

### CROSS-REFERENCE TO RELATED APPLICATIONS

This application claims the benefit of U.S. Provisional Application No. 62/003,920, filed May 28, 2014, the disclosure of which is incorporated herein by reference.

### BACKGROUND OF THE INVENTION

This invention relates in general to power transfer assemblies. In particular, this invention relates to a power take off unit that is configured to provide a clutch engagement rate that reduces shock loads. This invention further relates to a power take off unit having a clutch engagement rate that can be generally matched to the inertia characteristics of a range of driven equipment or a particular piece of driven equipment. In addition, this invention relates to a power take off unit having a clutch engagement system where the rate of clutch actuation is adjustable.

Power take off (PTO) units transfer power from a power source, such as a transmission or engine, to a driven piece of equipment, such as a pump, generator, or other rotating component, typically by way of meshing gear trains. In order to selectively operate the driven equipment, PTO units typically include a mechanism to engage and disengage the gear train in order to start or stop the flow of power to the driven equipment. Often, PTO units rely on clutches to selectively couple the power source to the driven equipment. Clutches operate by compressing one or more driven discs, coupled to the power source, against one or more driving discs, coupled to the driven equipment. The one or more driven discs or driving discs may be configured as friction plates that are compressed against the other of the one or more driven or driving discs, configured as steel plates to aid in power transfer and permit controlled engagement of clutch assembly. Controlling the engagement of the clutch assembly is important to prevent damage to the PTO unit, the driven equipment and interconnecting shafts, and the power source. The damage can occur if shock loads are imparted to the system as power is abruptly transferred from the power source to the driven equipment.

Controlled engagement of the clutch assembly includes consideration, in part, of two system characteristics—inertia and actuation acceleration. Inertia is a function of the operating system, such as the type of driven equipment, including parameters such as the system rotating mass and loads imparted by the end use device and the power source being used. There is little that can be adjusted to change the inertia characteristics of the driven equipment once the system has been selected. The actuation acceleration controls how fast or “hard” the clutch engages and transfers power from the power source to the driven equipment. Too fast of an actuation speed creates a torque spike in the system that can damage components. Too slow of an actuation speed causes the slippage within the clutch which will damage the clutch assembly.

It would be advantageous to provide a PTO unit having a clutch system that could control the actuation acceleration of the clutch assembly to prevent inertia damage and excessive clutch wear. It would further be advantageous to provide a clutch actuation system that can be adjusted to tailor the clutch actuation acceleration to the specific inertia of the attached driven equipment system.

### SUMMARY OF THE INVENTION

This invention relates to a power take off unit that is configured to provide a clutch engagement rate that reduces shock loads. This invention further relates to a power take off unit having a clutch engagement rate that can be generally matched to the inertia characteristics of a range of driven equipment or a particular piece of driven equipment. In addition, this invention relates to a power take off unit having a clutch engagement system where the rate of clutch actuation is adjustable.

In a first aspect of the invention, a power take off unit includes a housing and an input gear train rotatably supported by the housing. A clutch assembly includes a driving housing, a driven housing, and an actuation piston. The clutch assembly is supported within the housing. The driving housing is connected to the input gear train. An output shaft has a hydraulic circuit that includes a primary feed that is in fluid communication with a secondary feed. The primary feed is configured to receive a flow of fluid from a hydraulic fluid source. The secondary feed is in fluid communication with the actuation piston. At least one of the primary and secondary feeds has a diameter configured to provide a clutch engagement rate that is proportional to a driven equipment moment of inertia to substantially prevent shock loading.

In a second aspect of the invention, a power take off unit includes an input gear train connected to an external power source. A clutch assembly has a driving collar, a driven collar, and a clutch pack positioned between the driving and driven collars. The clutch pack includes a plurality of driving plates engaging the driving collar and a plurality of driven plates interposed between the plurality of driving plates and engaging the driven collar. The driving collar is connected to the input gear train. An actuation piston is oriented to compress the clutch assembly. An output shaft is connected to the driven collar and includes a hydraulic circuit having a primary feed that is in fluid communication with a secondary feed. The primary feed receives a flow of fluid from a hydraulic fluid source. The secondary feed is in fluid communication with the actuation piston. The primary feed has a diameter in a range of about 0.38 inches (9.65 mm) to about 0.06 inches (1.52 mm) and the secondary feed having a diameter that is smaller than the primary feed diameter. The secondary feed diameter is directly proportional to a driven equipment moment of inertia to define a clutch engagement rate.

A feature of the second aspect of the invention defines the secondary feed diameter to be in a range of about 0.09 inches (2.29 mm) to about 0.016 inches (0.406 mm) which produces a clutch engagement rate of about 100 milliseconds for the driven equipment moment of inertia in a range of 0.006 LB-FT² to about 20 LB-FT².

In a third aspect of the invention, a vehicle-mounted power take off unit includes an input gear train connected to a vehicle-mounted power source. A clutch assembly is driven by an actuation piston to selectively engage the input gear train to an output shaft. A driven equipment load is coupled to the output shaft and has a moment of inertial in a range of about 0.006 LB-FT² to about 20 LB-FT². A hydraulic circuit receives a flow of fluid from a hydraulic fluid source and delivers the flow of fluid to the actuation piston such that the clutch assembly engages the input gear train to the output shaft in about 100 milliseconds.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a cross sectional view of a power take-off (PTO) unit having a clutch actuation control circuit in accordance with the invention.

FIG. 2A is the PTO clutch support shaft of FIG. 1, in partial cross section, showing a first embodiment of a clutch actuation control circuit.

FIG. 2B is an exploded view of a second embodiment of a clutch actuation control circuit.

FIG. 2C is an enlarged view of a portion of the clutch actuation control circuit of FIG. 2B.

FIG. 3A is an exploded view of a third embodiment of a portion of a clutch actuation control circuit.

FIG. 3B is an end view of a control orifice of the clutch actuation control circuit of FIG. 3A.

FIG. 4 is a chart of test results of PTO shaft torque versus clutch control orifice diameter for a driven auxiliary piece of equipment having a mass moment of inertia.

FIG. 5 is a chart of estimated clutch engagement times for the orifice tests of FIG. 4.

FIG. 6 is a chart of confirmation tests of PTO shaft torque versus clutch control orifice diameter for a driven auxiliary piece of equipment having a mass moment of inertia, similar to FIG. 4.

FIG. 7 is a chart of confirmation estimated clutch engagement times for the orifice tests of FIG. 6, similar to FIG. 5.

### DETAILED DESCRIPTION OF THE PREFERRED EMBODIMENTS

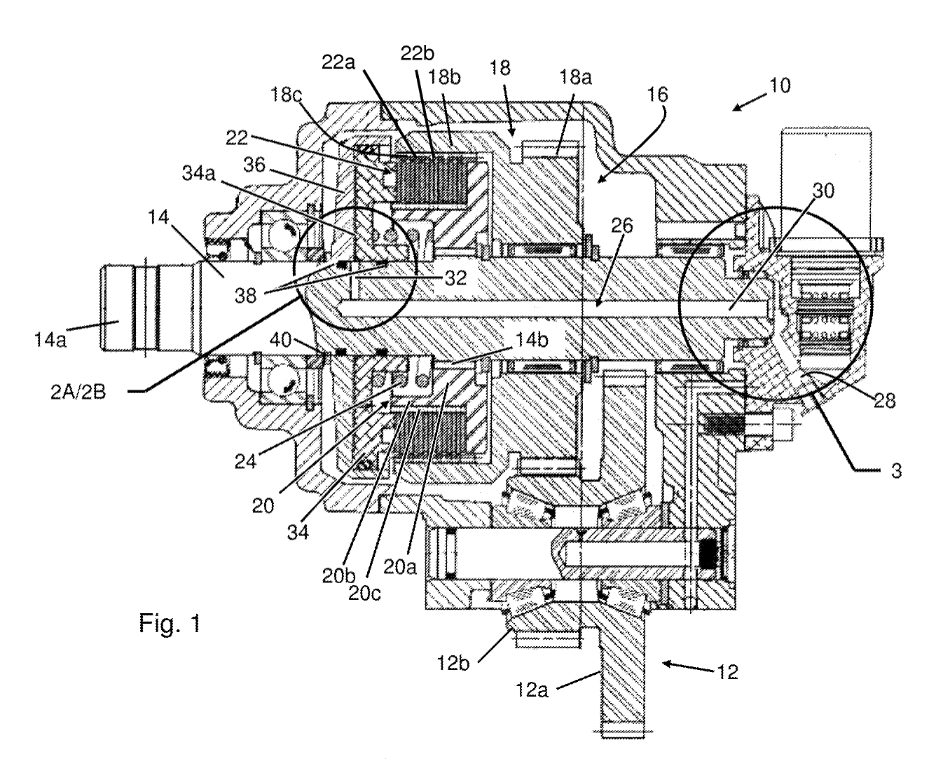

Referring now to the drawings, there is illustrated in FIG. 1 a power take-off (PTO) unit, shown generally at 10. Though shown and described in the context of a PTO unit, the various embodiments of the invention described below may be used in conjunction with any hydraulically actuated clutch system having a through-shaft hydraulic clutch actuation control circuit. The PTO unit 10 is configured to accept power input from a primary drive component, such as an engine or a transmission, and produce an output sufficient to drive an auxiliary device such as, for example, a hydraulic pump, air compressor, or electric generator. In the illustrated embodiment, the PTO unit 10 includes an input gear train, shown generally at 12, an output shaft 14 terminating in an output spline or keyway 14a and further having a drive gear or spline 14b, and a clutch assembly, shown generally at 16, that is connected between the input gear train 12 and the output shaft 14. The input gear train 12 includes an input gear 12a that connects to a power source, such as for example a transmission. An intermediate gear 12b is connected to the input gear 12a. Though illustrated as being integrally connected to the input gear 12a, the intermediate gear 12b may be directly or indirectly meshed or engaged to the input gear 12a. The gears are arranged such that the teeth are in a meshing engagement to transfer rotary motion and power from the input gear 12a to the output spline 14a. It should be understood that the gears may be provided in any number and in any mounting arrangement other than depicted and remain within the scope of the invention.

The clutch assembly 16 includes a driving housing 18 and a driven housing 20. The driving housing 18 includes a driving gear 18a, shown meshed to the intermediate gear 12b, and a driving collar 18b connected to the driving gear 18a. Though illustrated as being integrally connected to the driving housing 18, the driving gear 18a may be directly or indirectly meshed or engaged to the driving housing 18. The driving gear 18a and driving housing 18 are arranged such that they cooperate to transfer rotary motion and power from the driving gear 18a to driving housing 18 and to a clutch pack, as will be explained below. It should be understood that the gears and plates may be provided in any number and in any mounting arrangement other than depicted and remain within the scope of the invention. The driven housing 20 includes a driven gear 20a, shown engaging the drive gear 14b of the output shaft 14, and a driven collar 20b. Though illustrated as being integrally connected to the driven housing 20, the driven gear 20a may be directly or indirectly meshed or engaged to the driven housing 20. A clutch pack, shown generally at 22, includes driving plates 22a and driven plates 22b that are arranged in an alternating pattern. The driving collar 18b engages the driving plates 22a, typically by way of teeth formed on the outer surface of each driving plate, that engage corresponding longitudinal spline teeth 18c formed on the inner surface of the driving collar 18b. The driven collar 20b includes longitudinal teeth 20c formed on an outer surface that engage corresponding teeth formed around an inner diameter of the driven plates 22b. The driving and driven plates 22a and 22b are able to slide along the longitudinal teeth 18c and 20c of the respective driving and driven collars 18b and 20b as the clutch pack 22 is compressed and released. During compression, the clutch pack 22 transfers rotary motion and power from the driving housing 18 to the driven housing 20. A release spring 24 maintains the clutch pack 20 in a free spinning condition such that no torque or power is transferred from the driving housing 18 to the driven housing 20 until the spring force is overcome by a clutch actuation force.

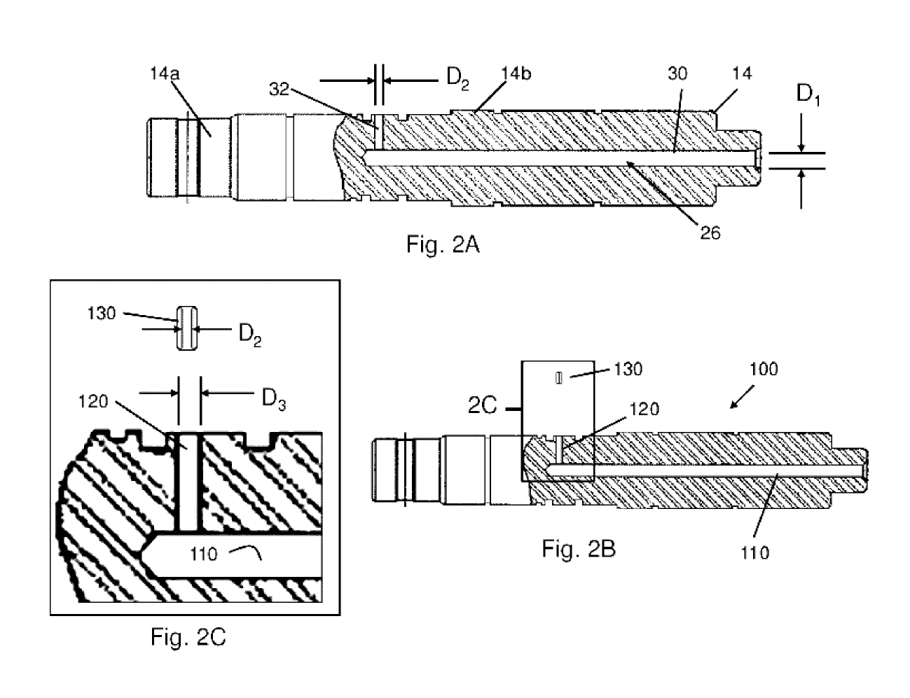

Referring to FIGS. 1 and 2A, the output shaft 14 of the PTO unit 10 includes a hydraulic actuation circuit, shown generally at 26. The output shaft 14 may, alternatively, be an intermediate shaft coupled to a gear set or an output shaft. The hydraulic circuit 26 of the output shaft 14 provides a fluid connection between the clutch assembly 16 and a source of hydraulic fluid pressure 28, which may be an external source connected to the PTO unit 10. The source of hydraulic fluid pressure 28 provides the force necessary to compress the clutch pack 22 against the force of the release spring 24 in order to energize the clutch and transfer power from the input gear 12a to the output spline 14a. The hydraulic circuit 26 includes a primary feed 30, illustrated as a conduit extending along the centerline or central axis of the output shaft 14. The primary feed 30 is illustrated having a diameter of D1. In one embodiment, the diameter D1 may be in a range of about 0.38 (⅜) inches to about 0.06 ( 1/16) inches. The diameter D1 is selected to provide sufficient fluid flow to engage the clutch pack 22 over a broad range of operating conditions and to accommodate a range of output shaft lengths. In one embodiment, the range of output shaft lengths is from about 5 inches to about 32 inches. As output shaft length increases, the fluid resistance through the primary feed increases. Additionally, because the viscosity of hydraulic fluid varies based on ambient versus operating temperature conditions along with fluid type, diameter D1 is selected to permit sufficient fluid flow, over a temperature range of about −40° F. to about +250° F. In a specific embodiment of the primary feed 30, the diameter D1 is about 0.125 (⅛) inches.

The primary feed 30 connects to a secondary feed 32 having a diameter D2 that is smaller than the primary feed diameter D1. In one embodiment where the primary feed 30 has a diameter of about 0.125 inches, the secondary feed 32 may have the diameter D2 in a range of about 0.09 ( 3/32) inches to about 0.016 ( 1/64) inches. In another embodiment, the diameter D2 may be in a range of about 0.06 ( 1/16) inches to about 0.025 inches. In yet another embodiment, D2 is about 0.03 ( 1/32) inches. In one aspect of these embodiments, a consideration may be made to maintain the secondary feed diameter D2 larger than a hydraulic system bleed hole (not shown). In one embodiment, the diameter D2 may be about 0.03 ( 1/32) inches and the bleed hole diameter may be about 0.025 inches, having a ratio of about 1.24. In another embodiment, the ratio of secondary feed diameter D2 to bleed hole diameter may be about 1.50 to about 1.10. Prior art secondary feeds have been known to have the same diameter, D1, as the primary feed 30. However, such a large diameter secondary feed can support a clutch engagement rate in a range of about 0.01 seconds to about 0.05 seconds. This clutch engagement rate has been found to be too fast to permit smooth start-up of equipment mounted downstream of the PTO unit 10. Particularly, if the downstream equipment has a high inertia, or resistance to motion, as the clutch engagement speed becomes faster, the driveline and PTO unit 10 are subjected to larger torque spikes. For example, a small hydraulic pump may have a moment of inertia of 0.006 LB-FT², while a large PTO driven blower may have a moment of inertia of over 20 LB-FT². This large difference in inertia values creates shock loading conditions and clutch plate wear issues for a PTO having a fixed clutch engagement rate that may operate such a variety of driven equipment.

Referring still to FIGS. 1 and 2A, the secondary feed 32 is illustrated extending from the primary feed 30 at a generally perpendicular angle, though the secondary feed may extend at any suitable angle desired. The secondary feed 32 supplies hydraulic fluid and the attendant clutch actuation force to a clutch actuation piston 34. The clutch actuation piston 34 may abut a stop plate 36 that is connected to the output shaft 14. As shown in FIG. 1, seals 38 are disposed between the output shaft 14 and the actuation piston 34 and stop plate 36. The seal 38 positioned between the piston 34 and the output shaft 14 permits axial movement of the piston along the shaft 14 in response to the actuating fluid pressure. The stop plate 36 is prevented from axially moving by a snap ring 40 seated on the output shaft 14. Thus, the fluid pressure is directed to the piston 34 against the clutch pack 22. The hydraulic fluid flow from the secondary feed 32 is directed to a crown 34a of the actuation piston 34. The crown 34a seats against the stop plate 36 in response to forces from the release spring 24.

Referring now to FIGS. 2B and 2C, there is illustrated another embodiment of an output shaft, shown generally at 100, that may be used in the PTO unit 10, described above, in place of the output shaft 14. The output shaft 100 includes a primary feed 110, similar in configuration to primary feed 30 described above. The primary feed 110 may have a diameter D1 within the ranges of diameter D1 of the primary feed 30. A secondary feed 120 is illustrated intersecting the primary feed 110 to provide fluid communication between the source of hydraulic fluid and the clutch assembly 16. The secondary feed 120 has a diameter D3, that may be larger, smaller, or the same size as diameter D1. The diameter D3 is sized to provide a flow of hydraulic fluid that is the same as D1 or at least is greater than the flow necessary to provide a soft start clutch engagement. The soft start clutch engagement is defined as the clutch engagement speed that substantially reduces or eliminates a torque spike in the powertrain system to which the PTO unit is installed by balancing the inertia of the driven equipment against the torque available from the engine or transmission that is used to drive the driven equipment. In addition, the clutch engagement speed takes into account the amount and extent of relative slip motion between driving and driven plates and the clutch facing material to provide adequate operating life.

Diameter D3 is also sized to permit an orifice 130 to be inserted to restrict the flow of hydraulic fluid to the clutch assembly 16 to an appropriate level to provide the soft start capability. In a specific aspect of this embodiment, the outer diameter of the orifice 130 is sized to be a press fit or interference fit such that, once installed, the orifice 130 cannot be easily removed from the secondary feed 120. As illustrated, the orifice 130 has an inner diameter D2 that is within the same general ranges as the diameter D2 of the secondary feed 32 described above. The ability to produce a single output shaft 100 that can be adapted to flow-restrict the hydraulic circuit to permit a soft start clutch engagement for a wide variety of driven equipment configurations helps standardize manufacturing processes and tooling to minimize machining costs and tooling setups.

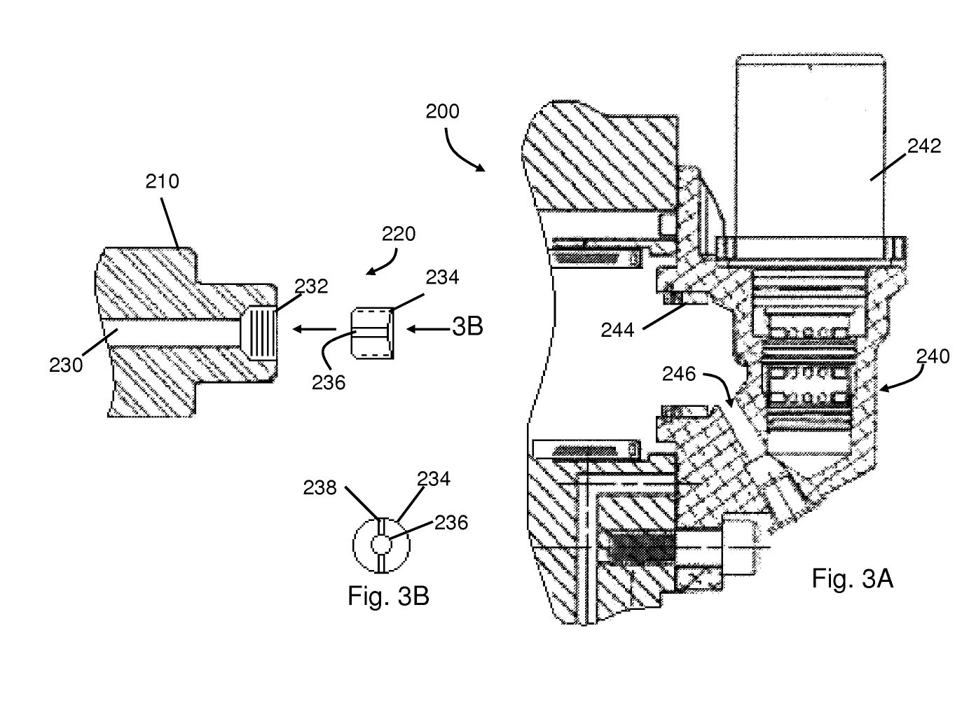

Referring now to FIGS. 3A and 3B, there is illustrated another embodiment of a PTO unit, shown generally at 200, having an output shaft 210 that includes a hydraulic circuit, a portion of which is shown generally at 220. The hydraulic circuit 220 of the output shaft 210 includes a primary feed 230. The PTO unit 200 is illustrated as an exploded view showing the output shaft 210 removed. The PTO unit 200 includes a rear cover assembly 240 having a solenoid valve 242, an output shaft support member 244 and a hydraulic circuit input 246. The primary feed 230 of the output shaft 210 includes a receiving pocket 232, illustrated as a threaded aperture, that accepts a metering plug 234 having an orifice 236. The orifice 236 may have a diameter D2 that is similar in size range to the diameter D2, described above. The metering plug 234 is oriented at the end of the output shaft 210 and in close proximity to the rear cover assembly 240 in order to provide easy access thereto. In the illustrated embodiment, the rear cover assembly 240 may be removed and the metering plug 232, which includes a torque transmitting feature 238 (shown as a slot for a screwdriver) to permit easy removal. This provides the ability to optimize the clutch engagement speed for the specific piece of driven equipment, particularly if modifications are required in the field. Thus, the metering plug 234 may be changed to more closely match the equipment requirements, even where those requirements change over time.

As driven equipment inertias increase, a corresponding delay or slowing of equipment acceleration speeds results in reduced torsional impact loads being generated and transmitted to driveline and PTO unit components. Additionally, if driven equipment inertias are in the lower ranges, above, higher clutch engagement rates provide acceptable torsional resultant forces and improved clutch life. The secondary feed diameter ranges (identified in the respective embodiments, above, as D2 or D3), above, are adjusted such that a timed delay in clutch lock-up or full engagement results in a reduced torsional impact load generated at full clutch lock-up. It has also been found that an upper limit to this timed lock-up delay (i.e., longer time to engage) is clutch slippage resulting in a temperature rise in excess of the driving and driven plate materials, which equates to greater than expected clutch wear and reduced clutch life. While some amount of clutch slippage is the mechanism that permits full engagement delay, excessive slippage results in a temperature rise that damages friction plates and mating driving or driven plate surfaces. Such damage may be associated with galling of mating clutch surfaces, localized surface welding, and glazing resulting in a reduced frictional interface between driving and driven members. Thus, as driven equipment inertias increase, for a given PTO unit 10 having a given output shaft length L, the diameter D2 (or D3) is reduced from the diameter of the primary feed D1. Correspondingly, as the driven equipment inertias become smaller in magnitude, the diameter D2 (or D3) may become larger, approaching diameter D1. In addition to the inverse correspondence of secondary feed diameter to driven equipment inertia, considerations of fluid impedance in the primary feed line due to the length of the output shaft may also be applied. For example, as the length of the primary feed increases, a larger secondary feed diameter may be used to provide a desired clutch engagement speed for a particular driven equipment inertia.

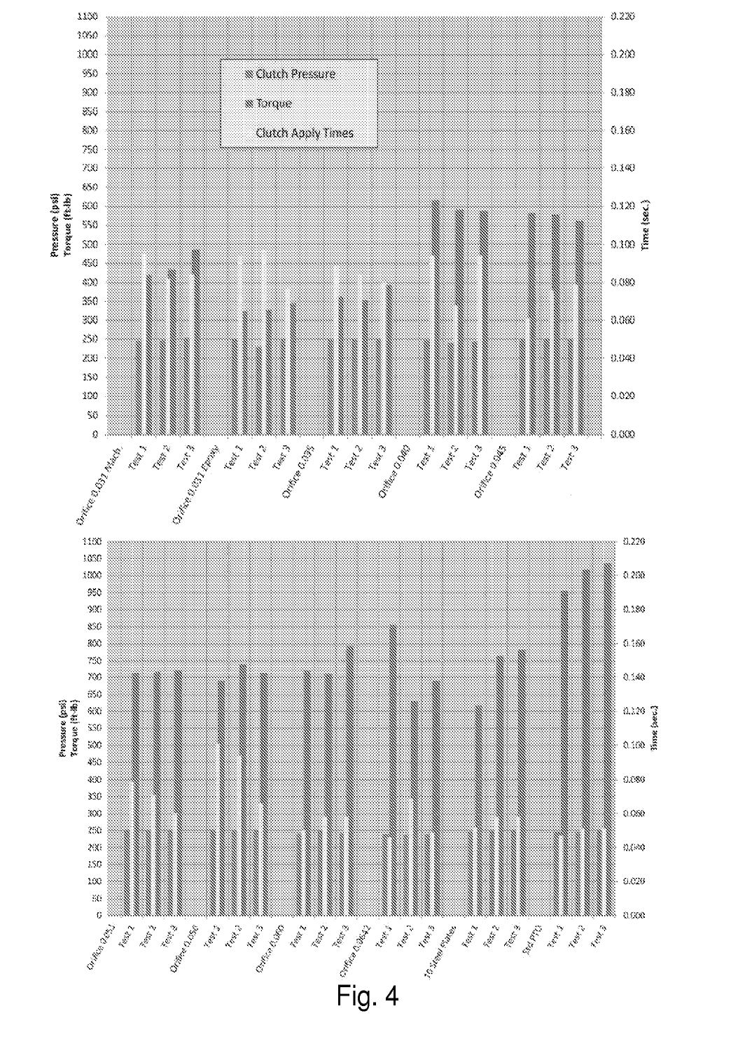

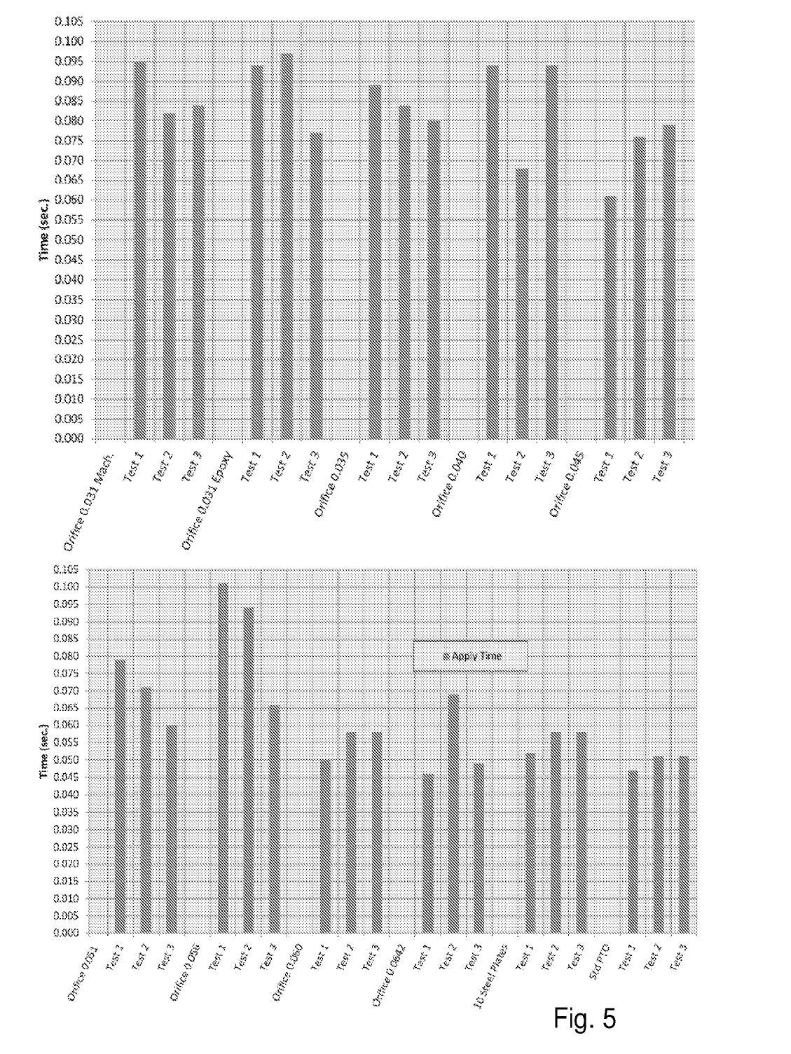

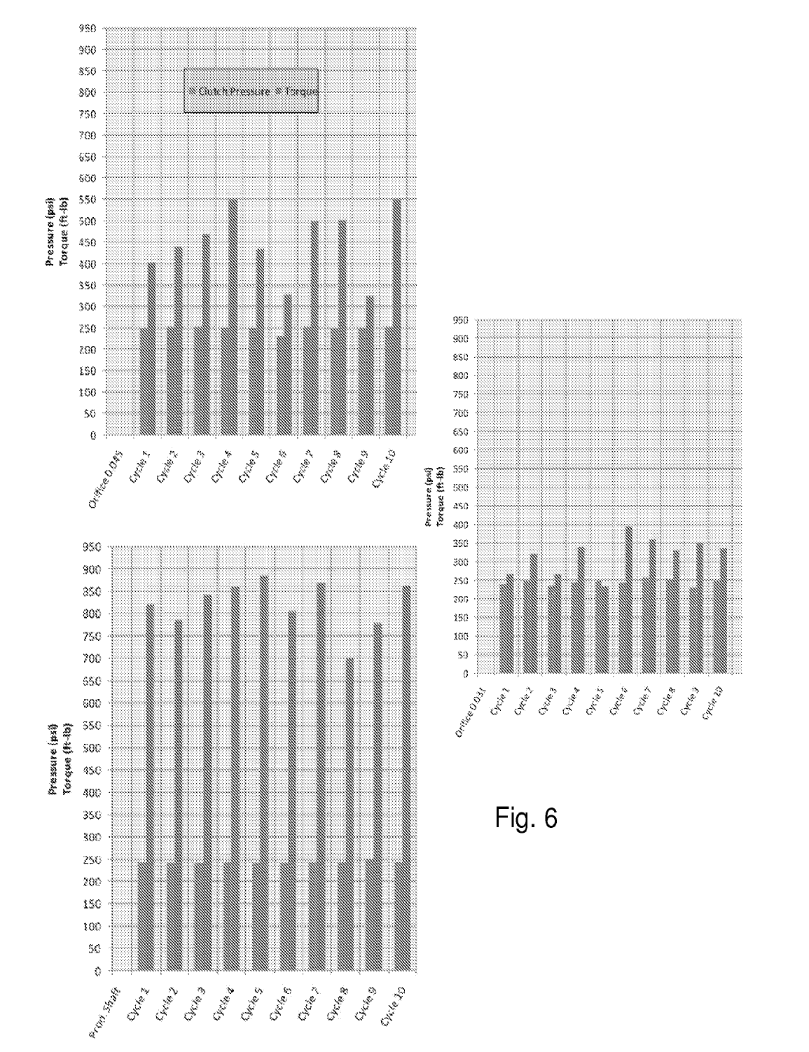

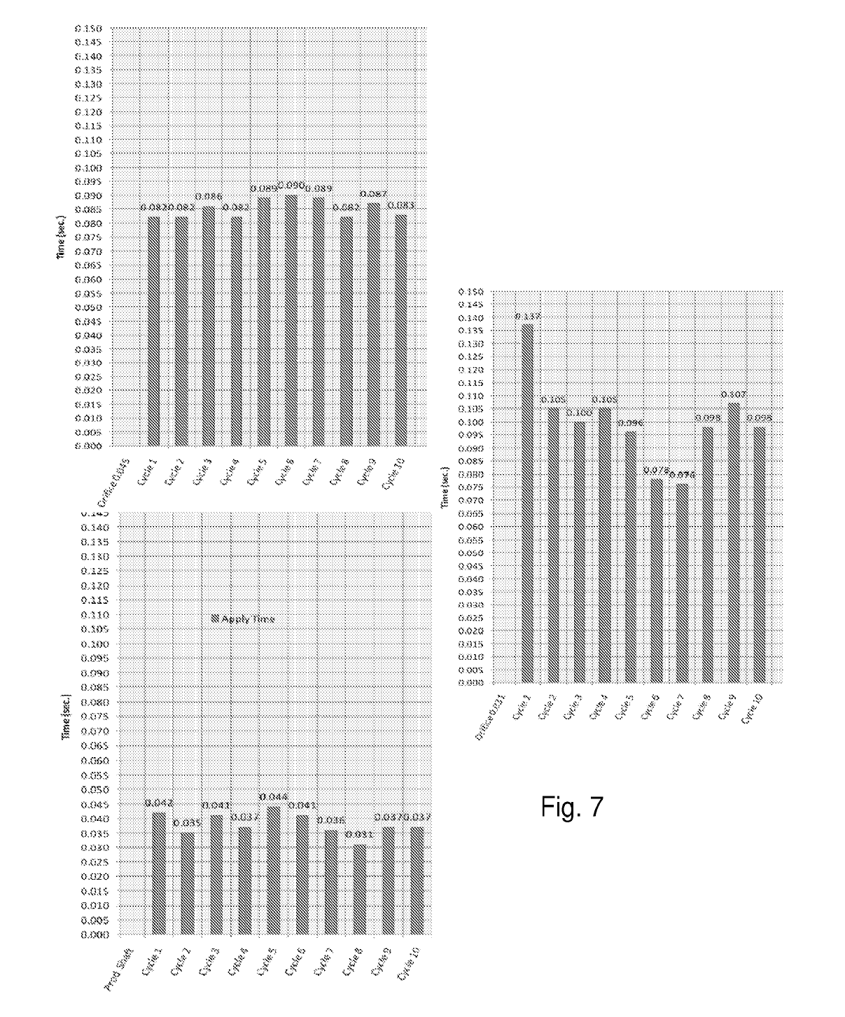

Referring now to FIGS. 4-7, there are shown various test results relating orifice size to torque spikes at the output shaft 14 of the PTO unit when driving an auxiliary device, such as a 185 CFM rated air compressor. As shown in FIGS. 4 and 6, as the orifice diameter increases, the clutch engagement torque spikes become larger. In addition, the clutch engagement times become shorter, as shown in FIG. 5. It is noteworthy that the clutch engagement time estimates do not sharply change, for a given equipment inertia value, until the orifice size nearly doubles. Additionally, for the given inertia of the driven auxiliary equipment, the clutch engagement time is similar for a standard production secondary feed diameter of about 0.125 inches. The clutch engagement torque spikes are shown in FIGS. 4 and 6 to be minimized, thus reducing the torsional load spikes that cause damage to PTO components. As shown in FIG. 7, clutch engagement times of about 100 milliseconds are sufficient to provide adequate clutch life.

The principle and mode of operation of this invention have been explained and illustrated in its preferred embodiments. However, it must be understood that this invention may be practiced otherwise than as specifically explained and illustrated without departing from its spirit or scope.

1. A power take off unit comprising:
a housing;
an input gear train rotatably supported by the housing;
a clutch assembly having a driving housing, a driven housing, and an actuation piston, the clutch assembly supported within the housing, the driving housing connected to the input gear train; and
an output shaft having a hydraulic circuit, the hydraulic circuit having a primary feed that is in fluid communication with a secondary feed, the primary feed configured to receive a flow of fluid from a hydraulic fluid source and the secondary feed being in fluid communication with the actuation piston, at least one of the primary and secondary feeds having a diameter configured to provide a clutch engagement rate that is proportional to a driven equipment moment of inertia to substantially prevent shock loading.

2. The power take off unit of claim 1 wherein the diameter of at least one of the primary feed and the secondary feed is about 0.03 inches.

3. The power take off unit of claim 1 wherein the primary feed extends generally along a central axis of the output shaft and the secondary feed extends at an angle between the primary feed and the actuation piston, the primary feed having a diameter in a range of about 0.38 inches to about 0.06 inches and the secondary feed having a diameter in a range of about 0.09 inches to about 0.016 inches.

4. The power take off unit of claim 3 wherein the diameter of the secondary feed is about 0.03 inches.

5. The power take off unit of claim 1 wherein the secondary feed includes an orifice having a bore with a diameter in a range of about 0.09 inches to about 0.016 inches.

6. The power take off unit of claim 5 wherein the bore of the orifice is about 0.03 inches.

7. The power take off unit of claim 1 wherein the hydraulic circuit of the output shaft includes a portion of the primary feed having a diameter in a range of about 0.09 inches to about 0.016 inches.

8. The power take off unit of claim 7 wherein the portion of the primary feed defines a receiving pocket that accepts a metering plug having an orifice, the metering plug configured for removal, and the orifice defining the diameter in the range of about 0.09 inches to about 0.016 inches.

9. The power take off unit of claim 8 wherein the metering plug is oriented at an end of the output shaft that is in generally close proximity to an access opening of the housing of the power take off unit.

10. The power take off unit of claim 1 wherein the primary feed extends generally along a central axis of the output shaft and defines a first diameter and the secondary feed defines a second diameter that is smaller than the first diameter, the second diameter delivering hydraulic fluid flow to the actuation piston such that the clutch assembly engages within a time of about 100 milliseconds when driving a device having a moment of inertia in a rage of about 0.004 LB-FT² to about 0.008 LB-FT².

11. The power take off unit of claim 10 wherein the first diameter is in a range of about 0.38 inches to about 0.06 inches that is proportional to an output shaft length of about 5 inches to about 32 inches.

12. The power take off unit of claim 11 wherein the second diameter is in a range of about 0.09 inches to about 0.016 inches.

13. The power take off unit of claim 1 wherein the primary feed extends generally along a central axis of the output shaft and defines a first diameter and the secondary feed defines a second diameter that is smaller than the first diameter, the second diameter delivering hydraulic fluid flow to the actuation piston such that the clutch assembly engages within a time of about 100 milliseconds when driving a device having a moment of inertia in a range of about 15 LB-FT² to about 25 LB-FT².

14. The power take off unit of claim 13 wherein the first diameter is in a range of about 0.38 inches to about 0.06 inches that is proportional to an output shaft length of about 5 inches to about 32 inches.

15. The power take off unit of claim 14 wherein the second diameter is about 0.03 inches.

16. A power take off unit comprising:
an input gear train connected to an external power source;
a clutch assembly having a driving collar, a driven collar, and a clutch pack positioned between the driving and driven collars, the clutch pack comprising a plurality of driving plates engaging the driving collar and a plurality of driven plates interposed between the plurality of driving plates and engaging the driven collar, the driving collar connected to the input gear train;
an actuation piston oriented to compress the clutch assembly; and
an output shaft connected to the driven collar, the output shaft having a hydraulic circuit including a primary feed that is in fluid communication with a secondary feed, the primary feed configured to receive a flow of fluid from a hydraulic fluid source and the secondary feed being in fluid communication with the actuation piston, the primary feed having a diameter in a range of about 0.38 inches to about 0.06 inches and the secondary feed having a diameter that is smaller than the primary feed diameter, the secondary feed diameter being directly proportional to a driven equipment moment of inertia to define a clutch engagement rate.

17. The power take off unit of claim 16 wherein the secondary feed diameter is in a range of about 0.09 inches to about 0.016 inches and produces a clutch engagement rate of about 100 milliseconds for the driven equipment moment of inertia in a range of 0.006 LB-FT² to about 20 LB-FT².

18. The power take off unit of claim 16 wherein the secondary feed diameter is about 0.03 inches.

19. A vehicle-mounted power take off unit comprising:
an input gear train connected to a vehicle-mounted power source;
a clutch assembly driven by an actuation piston to selectively engage the input gear train to an output shaft;
a driven equipment load coupled to the output shaft and having a moment of inertia in a range of about 0.006 LB FT² to about 20 LB FT²; and
a hydraulic circuit configured to receive a flow of fluid from a hydraulic fluid source and deliver the flow of fluid to the actuation piston such that the clutch assembly engages the input gear train to the output shaft in about 100 milliseconds.

20. The vehicle-mounted power take off unit of claim 19 wherein the hydraulic circuit is formed into the output shaft and includes a primary feed that is in fluid communication with a secondary feed, the primary feed and the secondary feed being in fluid communication with the actuation piston, the primary feed having a diameter in a range of about 0.38 inches to about 0.06 inches and the secondary feed having a diameter that is smaller than the primary feed diameter, the secondary feed diameter being directly proportional to a driven equipment moment of inertia to define a clutch engagement rate.
